(19) United States
(12) Patent Application Publication
(10) Pub. No.: US 2010/0310913 A1
(43) Pub. Date: Dec. 9, 2010

(54) Rechargeable battery and method of manufacturing the same

(76) Inventors: Sung-Kab Kim, Suwon-si (KR); Sung-Hoon Kim, Suwon-si (KR); Hyung-Keun Lee, Suwon-si (KR); Yong-Sam Kim, Suwon-si (KR); Sung-Bae Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/801,172

(22) Filed: May 26, 2010

(30) Foreign Application Priority Data
Jun. 4, 2009 (KR) 10-2009-0049641

(51) Int. Cl. H01M 6/10; H01M 10/04

(52) U.S. Cl. 429/94; 29/623.2

(57) ABSTRACT

A rechargeable battery and method of manufacturing the same, the rechargeable battery including an electrode assembly including a spirally wound separator, positive electrode, and negative electrode, a case housing the electrode assembly, a cap plate including a terminal hole and sealing an opening in one side of the case, an electrode terminal in the terminal hole of the cap plate and extending inwardly inside the case and outwardly from the case, and a lead tab having one side connected to the electrode terminal inside the case and another side connected to the electrode assembly, the lead tab including silver (Ag).

### BACKGROUND

1. Field

Embodiments relate to a rechargeable battery and a method of manufacturing the same.

2. Description of the Related Art

A rechargeable battery may include an electrode assembly having a jelly roll configuration. In other words, the electrode assembly may include a separator and an positive electrode and negative electrode provided on opposing surfaces of the separator and wound together. The rechargeable battery may also include a case that houses the electrode assembly, a cap plate that closes and seals an opening of the case, an electrode terminal electrically connected to the electrode assembly and protruding outside of the cap plate through a terminal hole in the cap plate, and a lead tab connecting the negative electrode or positive electrode of the electrode assembly to each of the electrode terminals.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery and a method of manufacturing the same, which represent advances over the related art.

It is a feature of an embodiment to provide a rechargeable battery that minimizes electrical resistance of a lead tab connecting an electrode assembly and an electrode terminal.

At least one of the above and other features and advantages may be realized by providing a rechargeable battery including an electrode assembly including a spirally wound separator, positive electrode, and negative electrode, a case housing the electrode assembly, a cap plate including a terminal hole and sealing an opening in one side of the case, an electrode terminal in the terminal hole of the cap plate and extending inwardly inside the case and outwardly from the case, and a lead tab having one side connected to the electrode terminal inside the case and another side connected to the electrode assembly, the lead tab including silver (Ag).

The lead tab may include a body made of a metal and a silvered layer on a surface of the body.

The lead tab may further include a zincated layer between the body and the silvered layer.

The zincated layer may have a thickness of less than about 1 μm.

The lead tab may further include a chromated layer on the silvered layer.

The zincated layer, the silvered layer, and the chromated layer may have a total thickness of about 1 μm to about 5 μm.

The lead tab may further include a chromated layer on the silvered layer.

The body may be made of one of copper (Cu) or aluminum (Al).

At least one of the above and other features and advantages may also be realized by providing a method of manufacturing a rechargeable battery, the method including supplying an electrode assembly, the electrode assembly including a spirally wound separator, a positive electrode, and a negative electrode; housing the electrode assembly in a case; sealing an opening in one side of the case with a cap plate, the cap plate including a terminal hole; supplying an electrode terminal in the terminal hole of the cap plate, the electrode terminal extending inwardly inside the case and outwardly from the case; and supplying a lead tab, the lead tab having one side connected to the electrode terminal inside the case and another side connected to the electrode assembly, wherein supplying the lead tab includes degreasing a surface of a lead tab body; forming a zincated layer on the surface of the degreased lead tab body; washing a surface of the zincated layer; and forming a silver layer on the surface of the zincated layer.

A thickness of the zincated layer may be about 1 μm or less.

Degreasing the surface of the lead tab body may be performed using a sodium hydroxide solution having a concentration of at least about 0.1 M.

Forming the zincated layer may be performed using a solution including about 7 to about 30 g/l of zinc metal, about 10 to about 60 g/l of zinc cyanide, about 10 to about 40 g/l of zinc sodium, and about 30 to about 100 g/l of a 2-3 M sodium hydroxide solution.

Forming the silvered layer may be performed using a solution including about 20 to about 50 g/l of silver cyanide, about 30 to about 70 g/l of sodium cyanide, and about 80 to about 150 g/l of potassium cyanide.

Supplying the lead tab may further include forming a chromated layer on a surface of the silvered layer.

A total thickness of the zincated layer, the silvered layer, and the chromated layer may be about 1 μm to about 5 μm.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a rechargeable battery according to an embodiment;

FIG. 2 illustrates a cross-sectional view of FIG. 1, taken along the line II-II;

FIG. 3 illustrates an exploded perspective view of a lead tab and an electrode assembly; and

FIG. 4 illustrates a cross-sectional view of FIG. 3, taken along the line IV-IV.

### DETAILED DESCRIPTION

Korean Patent Application No. 10-2009-0049641, filed on Jun. 4, 2009, in the Korean Intellectual Property Office, and entitled: “Rechargeable Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

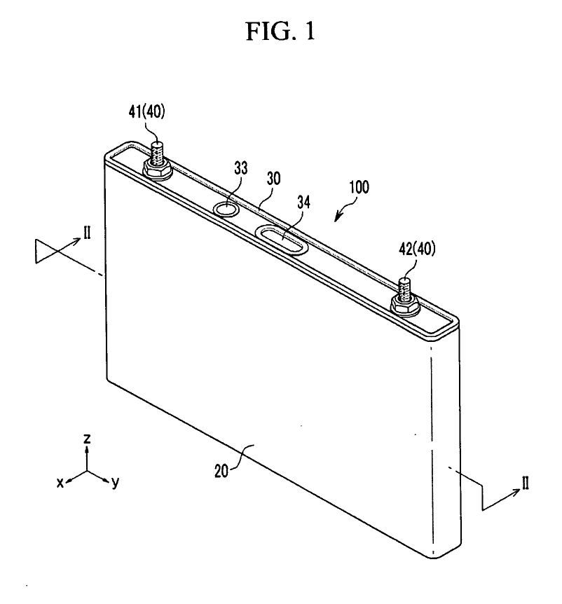

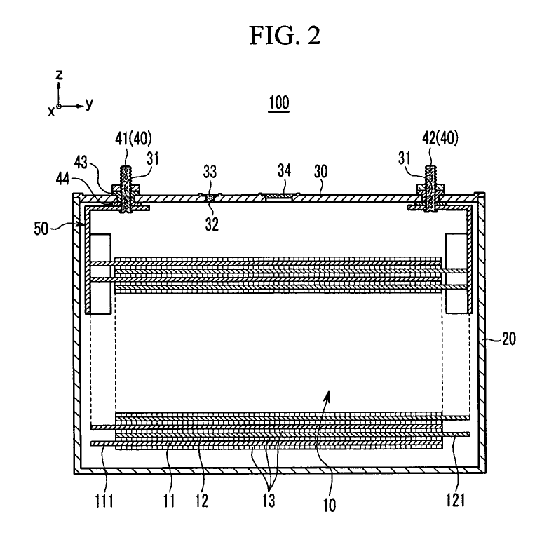

FIG. 1 illustrates a perspective view of a rechargeable battery according to an embodiment. FIG. 2 illustrates a cross-sectional view of FIG. 1, taken along the line II-II. Referring to FIGS. 1 and 2, a rechargeable battery 100 may include a case 20 housing an electrode assembly 10, a cap plate 30 closing and sealing an opening at one side of the case 20, electrode terminals 40 in terminal holes 31 of the cap plate 30, and lead tabs 50 connecting the electrode terminals 40 to the electrode assembly 10.

The electrode assembly 10 may be formed in a jelly roll configuration by disposing a positive electrode 11 and a negative electrode 12 on respective sides of a separator 13, which may be an insulator. Then, the positive electrode 11, the negative electrode 12, and the separator 13 may be spirally wound together.

The positive electrode 11 and the negative electrode 12 may each include a coated region where a current collector formed of a thin metal foil may be coated with an active material. The positive electrode 11 and the negative electrode 12 may each also include a positive uncoated region 111 and a negative uncoated region 121, respectively, where the current collector is not coated with the active material. The positive and negative uncoated regions 111 and 121 may be respectively formed at side ends of the positive electrode 11 and the negative electrode 12 in a length direction thereof.

One side of the respective lead tabs 50 may be connected to the positive and negative uncoated regions 111 and 121 disposed at opposite sides of the electrode assembly 10. Another side of each lead tab 50 may be connected to respective electrode terminals 40. The electrode terminals 40 may include a positive electrode terminal 41 and a negative electrode terminal 42. Therefore, the lead tabs 50 may be formed as a pair, and may connect the positive electrode 11 and the negative electrode 12 to the positive electrode terminal 41 and the negative electrode terminal 42, respectively.

The case 20 may form an entire exterior of the rechargeable battery 100. The case 20 may be made of a conductive metal, e.g., aluminum, an aluminum alloy, and/or nickel-plated steel. The case 20 may form a space that houses the electrode assembly 10. The case 20 may have, e.g., a prismatic hexahedron shape.

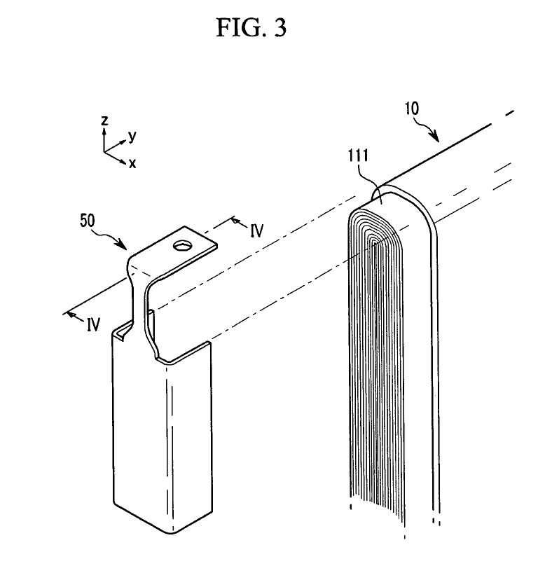

FIG. 3 illustrates an exploded perspective view of the lead tab and the electrode assembly. Referring to FIG. 3, the positive and negative uncoated regions 111 and 121 of the electrode assembly 10 included in the case 20 may be formed to be alike. Accordingly, the positive uncoated region 111 of the positive electrode 11 will now be exemplarily described.

The positive uncoated region 111 may be continuously wound so that an end of the uncoated region 111 may form lines that gradually increase in distance from a center of the electrode assembly 10. That is, end lines of the positive uncoated region 111 may include a straight line portion formed in a straight line along a z-axis direction and stacked in an x-axis direction. In addition, end lines of the positive uncoated region 111 may include an arc portion connected in a semi-circle or semi-oval shape at respective ends of the straight line portion in the z-axis direction and stacked in the z-axis direction.

Referring back to FIG. 1 and FIG. 2, the cap plate 30 may be formed of, e.g., a thin plate, and may be coupled to an opening formed at one side of the case 20 to seal the opening. The cap plate 30 may have an electrolyte injection opening 32 for injection of an electrolyte solution into the sealed space. The electrolyte injection opening 32 may be sealed by a sealing tab 33 after injection of the electrolyte solution. In order to prevent explosion of the rechargeable battery 100 due to, e.g., an increase of internal pressure of the case 20, the cap plate 30 may have a vent portion 34 that may be opened for ventilation when an internal pressure of the rechargeable battery 100 reaches a predetermined level.

The electrode terminal 40 may be mounted by providing an outer insulator 43 and an inner insulator 44 in the terminal hole 31 of the cap plate 30. Portions of the electrode terminal 40 may extend outwardly and inwardly from the case 20 through the terminal hole 31.

The terminal hole 31, the inner insulator 44, and the outer insulator 43 may be formed to be alike in the positive electrode terminal 41 and the negative electrode terminal 42. Therefore, the terminal hole 31, the inner insulator 44, and the outer insulator 43 formed in the positive electrode terminal 41 will be exemplarily described.

The outer insulator 43 may be partially inserted into the terminal hole 31 from an external side of the cap plate 30 so as to electrically insulate the positive electrode terminal 41 and the cap plate 30. That is, the outer insulator 43 may insulate an external surface of the positive electrode terminal 41 and an external surface of the cap plate 30 and may simultaneously insulate the external surface of the positive electrode terminal 41 and an internal surface of the terminal hole 31.

The inner insulator 44 may electrically insulate the cap plate 30 and the lead tab 50 from inside the cap plate 30 corresponding to the terminal hole 31. That is, the inner insulator 44 may insulate an upper surface of the lead tab 50 and an inner surface of the cap plate 30.

One side of the lead tab 50 may be electrically connected to an end of the electrode terminal 40 and another side of the lead tab 50 may be electrically connected to the positive uncoated region 111 of the electrode assembly 10. For example, the lead tab 50 may surround the positive uncoated region 111 and, in this state, the lead tab 50 and the positive uncoated region 111 may be welded together. The same procedure may occur with the negative uncoated region 121.

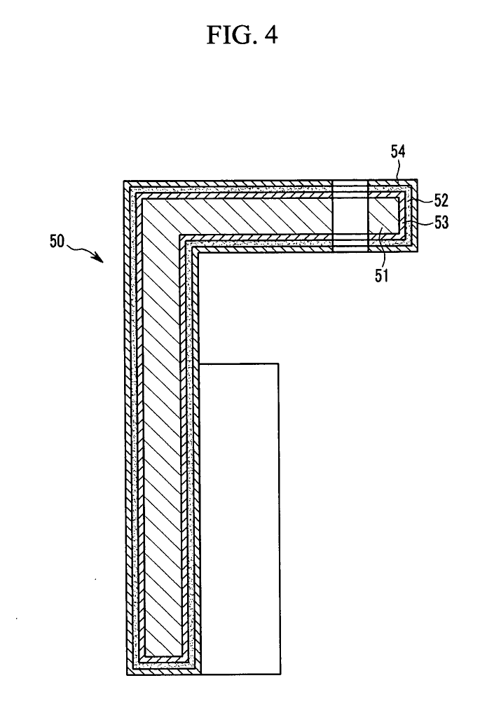

FIG. 4 illustrates a cross-sectional view of FIG. 3, taken long the line IV-IV of FIG. 3. Referring to FIGS. 2-4, the lead tab 50 may electrically connect the electrode assembly 10 and the electrode terminal 40, minimizing electrical resistance therebetween.

The lead tab 50 may include, e.g., silver (Ag). At room temperature, silver (Ag) has a resistivity of 1.63×10⁻⁸ Ωm, copper (Cu) has a resistivity of 1.70×10⁻⁸ Ωm, and aluminum (Al) has a resistivity of 2.65×10⁻⁸ Ωm. Here, the resistivity is inversely proportional to electrical conductivity. Therefore, the lead tab 50 including silver (Ag) has lower electrical resistance and higher conductivity, when compared to the other materials.

In an implementation, the lead tab 50 may include a body 51 and a silvered layer 52 on the surface of the body 51. In this case, the body 51 may be made of metal that is less expensive than silver (Ag), so that production costs may be reduced. The slivered layer 52 may form the surface of the lead tab 50 through which a relatively large amount of current may flow, so that electrical resistance of the lead tab 50 may be maximally decreased.

The body 51 may be made of, e.g., copper (Cu) or aluminum (Al), so that production costs may be reduced. In an implementation, the body 51 of the lead tab 50 connected to the positive electrode 11 may be made of aluminum (Al), and the body 51 of the lead tab 50 connected to the negative electrode 12 may be made of copper (Cu).

As described above, aluminum (Al) may have excellent electrical conductivity, but it may still have lower electrical conductivity than copper (Cu) or silver (Ag). Silver (Ag) may have excellent weldability compared to aluminum (Al) or copper (Cu), and may decrease electrical resistance. Therefore, weldability between the positive and negative uncoated regions 111 and 121 of the electrode assembly 10 and the lead tab 50 including a silvered layer 52 may be improved.

The silvered layer 52 may be formed directly on a surface of the body 51 depending on a material of the body 51. Alternatively, the silvered layer 52 may be formed on the body 51 with an intermediate layer therebetween. In an implementation, the body 51 may be made of aluminum (Al), and therefore the lead tab 50 connected to the positive electrode 11 or the negative electrode 12 may further include an intermediate layer.

The intermediate layer may be formed as, e.g., a zincated layer 53, on the surface of the aluminum (Al) body 51. The zincated layer 53 may enable the silvered layer 52 to be easily formed on the surface of the lead tab 50.

In addition, the lead tab 50 may further include a chromated layer 54 on the silvered layer 52. The chromated layer 54 may prevent oxidation of the silvered layer 52 on the surface of the body 51 thereby maintaining electrical conductivity.

A process for forming the aluminum body 51, the zincated layer 53, the silvered layer 52, and the chromated layer 54 in the lead tab 50 will now be described. The layers may be coated on the body 51 by, e.g., an electroplating process.

First, a surface of the aluminum body 51 may be degreased. For example, a chemical degreasing process may be performed with a sodium hydroxide (NaOH) solution having a concentration of at least about 0.1 M for a predetermined time period.

The zincated layer 53 may then be formed on the surface of the degreased aluminum body 51. The zincated layer 53 may be formed to a thickness of less than about 1 μm on the surface of the aluminum body 51. In the zinc coating process, a solution including about 7 to about 30 g/l of zinc metal, about 10 to about 60 g/l of zinc cyanide, about 10 to about 40 g/l of zinc sodium, and about 30 to about 100 g/l of a 2-3 M sodium hydroxide solution may be used. The zinc coating process may be performed at a temperature of about 25 to about 35° C., a current density of about 10 to about 100 mA/cm², and a voltage of about 3 to about 15 V.

The coated zincated layer 53 may then be washed to remove any foreign bodies. Subsequently, the washed zincated layer 53 may be coated with silver (Ag) to form the silvered layer 52.

In the silver coating process, a solution including about 20 to about 50 g/l of silver cyanide, about 30 to about 70 g/l of sodium cyanide, and about 80 to about 150 g/l of potassium cyanide may be used. The silver coating process may be performed at room temperature, with a current density of about 10 to about 50 mA/cm² and a voltage of about 3 to about 10 V.

After the silver coating process, a post-process may be performed. Then, the chromated layer 54 may be formed on the surface of the silvered layer 52 by, e.g., chromate processing with a small amount of chromium (Cr). The chromated layer 54 may prevent generation of impurities, e.g., Ag₂S and Ag₂SO₄, on the surface of the silvered layer 52 through reaction with SO₂ in the air, to thereby prevent discoloration and to maintain electrical conductivity of the silvered layer 52.

The zincated layer 53, the silvered layer 52, and the chromated layer 54 formed on the surface of the aluminum body 51 may have a total thickness of about 1 to about 5 μm. The silvered layer 52 may decrease electrical resistance of the surface the lead tab 50 through which a large amount of current may flow, such that a high efficiency rechargeable battery 100 may be efficiently charged and discharged.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A rechargeable battery, comprising;
an electrode assembly including a spirally wound separator, positive electrode, and negative electrode;
a case housing the electrode assembly;
a cap plate including a terminal hole and sealing an opening in one side of the case;
an electrode terminal in the terminal hole of the cap plate and extending inwardly inside the case and outwardly from the case; and
a lead tab having one side connected to the electrode terminal inside the case and another side connected to the electrode assembly, the lead tab including silver (Ag).

2. The rechargeable battery as claimed in claim 1, wherein the lead tab includes a body made of a metal and a silvered layer on a surface of the body.

3. The rechargeable battery as claimed in claim 2, wherein the lead tab further includes a zincated layer between the body and the silvered layer.

4. The rechargeable battery as claimed in claim 3, wherein the zincated layer has a thickness of less than about 1 μm.

5. The rechargeable battery as claimed in claim 3, wherein the lead tab further includes a chromated layer on the silvered layer.

6. The rechargeable battery as claimed in claim 5, wherein the zincated layer, the silvered layer, and the chromated layer have a total thickness of about 1 μm to about 5 μm.

7. The rechargeable battery as claimed in claim 2, wherein the lead tab further includes a chromated layer on the silvered layer.

8. The rechargeable battery as claimed in claim 2, wherein the body is made of one of copper (Cu) or aluminum (Al).

9. A method of manufacturing a rechargeable battery, the method comprising:
supplying an electrode assembly, the electrode assembly including a spirally wound separator, a positive electrode, and a negative electrode;
housing the electrode assembly in a case;
sealing an opening in one side of the case with a cap plate, the cap plate including a terminal hole;
supplying an electrode terminal in the terminal hole of the cap plate, the electrode terminal extending inwardly inside the case and outwardly from the case; and
supplying a lead tab, the lead tab having one side connected to the electrode terminal inside the case and another side connected to the electrode assembly,
wherein supplying the lead tab includes:
degreasing a surface of a lead tab body;
forming a zincated layer on the surface of the degreased lead tab body;
washing a surface of the zincated layer; and
forming a silver layer on the surface of the zincated layer.

10. The method as claimed in claim 9, wherein a thickness of the zincated layer is about 1 μm or less.

11. The method as claimed in claim 9, wherein degreasing the surface of the lead tab body is performed using a sodium hydroxide solution having a concentration of at least about 0.1 M.

12. The method as claimed in claim 9, wherein forming the zincated layer is performed using a solution including about 7 to about 30 g/l of zinc metal, about 10 to about 60 g/l of zinc cyanide, about 10 to about 40 g/l of zinc sodium, and about 30 to about 100 g/l of a 2-3 M sodium hydroxide solution.

13. The method as claimed in claim 9, wherein forming the silvered layer is performed using a solution including about 20 to about 50 g/l of silver cyanide, about 30 to about 70 g/l of sodium cyanide, and about 80 to about 150 g/l of potassium cyanide.

14. The method as claimed in claim 9, wherein supplying the lead tab further includes forming a chromated layer on a surface of the silvered layer.

15. The method as claimed in claim 10, wherein a total thickness of the zincated layer, the silvered layer, and the chromated layer is about 1 μm to about 5 μm.
